(19) United States
(12) Patent Application Publication
(10) Pub. No.: US 2024/0063489 A1
(43) Pub. Date: Feb. 22, 2024

(54) BATTERY ARRANGEMENT HAVING VIBRATION-DAMPED COVER AND METHOD FOR PRODUCING A BATTERY ARRANGEMENT FOR A MOTOR VEHICLE

(71) Applicant: AUDI AG, Ingolstadt (DE)

(72) Inventors: Wolfgang BECK, Aichach (DE); Thomas RIEDMANN, Eitensheim (DE)

(73) Assignee: AUDI AG, Ingolstadt (DE)

(21) Appl. No.: 18/365,314

(22) Filed: Aug. 4, 2023

(30) Foreign Application Priority Data
Aug. 17, 2022 (DE) 102022120721.8

(51) Int. Cl. H01M 50/242; H01M 50/209; H01M 50/249; H01M 50/258; H01M 10/613; H01M 10/625; H01M 10/6556; B60L 50/60; B60L 58/26

(52) U.S. Cl. CPC H01M 50/242; H01M 50/209; H01M 50/249; H01M 50/258; H01M 10/613; H01M 10/625; H01M 10/6556; B60L 50/66; B60L 58/26; H01M 2220/20

(57) ABSTRACT

A battery arrangement for a motor vehicle, includes a battery housing having a housing tray that provides a receiving area for receiving at least one battery module, and having a housing cover that is arranged on the housing tray. The battery arrangement has at least one battery component arranged in the battery housing and at a distance to the housing cover. At least one felt element for vibration damping of mechanical vibrations of the housing cover is arranged between the housing cover and the battery component, so that the at least one felt element abuts the housing cover and the at least one battery component.

### FIELD

The invention relates to a battery arrangement for a motor vehicle, wherein the battery arrangement includes a battery housing having a housing tray that provides a receiving area for receiving at least one battery module, and having a housing cover that is arranged on the housing tray. Furthermore, the battery arrangement comprises at least one battery component, which is arranged in the battery housing and is at a distance from the housing cover. The invention furthermore also relates to a method for producing a battery arrangement.

### BACKGROUND

In the case of high-voltage storage systems, the installation space size is increasing due to ever-increasing requirements. As a result, the area of the housing elements is also becoming larger and larger. Housing covers, for example, are largely designed as sheet metal parts that are screwed to the battery housing, in particular the housing tray, or the battery modules at regular intervals. Depending on the tolerance situation, temperature effects, design embodiments, temporary mechanical load, etc., this results in air gaps or contacts of the covers against adjacent components on the surfaces that are not screwed. The contacts can be permanent or also dynamic. In both cases, this will affect the adjoining components in terms of their pressure load, as well as in terms of the acoustics in the overall system, since components that strike one another dynamically result in rattling. Furthermore, mechanical loads applied to the system, for example lifting loads with a conceivable installation location of the storage device under the cargo floor or with improper handling of the high-voltage battery, can result in damage in the interior of the battery.

In addition, damping elements are also known from the prior art, which are often provided in the form of foams. Here, however, the introduction at the desired location is relatively difficult.

DE 10 2020 108 270 A1 describes a cooling device for cooling a battery module, which comprises multiple chambers which are delimited by a cover plate and a base plate and are designed so that a fluid can flow through them. Furthermore, a damping layer can also be arranged on the base plate on an outside facing away from the cover plate. The damping layer can be formed from a foam material such as a thermoplastic foam, for example, or from a composite material, in particular a fiber-reinforced plastic composite.

DE 11 2012 001 388 T5 describes a panel arrangement having a main panel having an acoustically active area, a primary adhesive layer, and a multi-layer patch having at least two individual patches and at least one adhesive auxiliary layer, wherein the primary adhesive layer fastens the multi-layer patch to the main panel in the acoustically active area for sound absorption. The main plate can consist of a sound-absorbing multi-layer arrangement.

Furthermore, DE 10 2020 126 174 A1 describes a battery system having a battery module and multiple battery cells, a battery housing having a housing base, and a clamping device having a clamping device. The clamping device includes an outer plate and an inner deformation plate, which together delimit a fluid-tight channel. In addition, the clamping device can also include an outer plate and the closing plate can be arranged on an outside of the outer plate facing away from the channel, wherein the closing plate and the outer plate are decoupled from one another via an at least partially interposed damping layer. The damping layer can be made of a foam material or a composite material.

### SUMMARY

It is the object of the present invention to provide a battery arrangement for a motor vehicle and a method which enable a reduction of acoustic abnormalities in the simplest possible manner.

A battery arrangement according to the invention for a motor vehicle includes a battery housing having a housing tray that provides a receiving area for receiving at least one battery module, and having a housing cover that is arranged on the housing tray. Furthermore, the battery arrangement includes at least one battery component, which is arranged in the battery housing and is at a distance from the housing cover. At least one felt element for vibration damping of mechanical vibrations of the housing cover is arranged between the housing cover and the battery component, so that the at least one felt element abuts the housing cover and the at least one battery component.

By providing such a felt element for vibration damping of mechanical vibrations, acoustic abnormalities can advantageously be significantly reduced. Because this felt element is arranged between the housing cover and the battery component and abuts both components at least temporarily but preferably permanently, any mechanical vibration of the housing cover is significantly damped. The particularly great advantage of the invention is above all the use of a felt material to provide the felt element. Felt is somewhat compressible and therefore has very good damping properties. However, felt is significantly less compressible than other materials typically used to damp mechanical vibrations, such as plastic foams or the like. In turn, this advantageously allows the felt element to be used very efficiently for damping mechanical vibrations, even if the distance between the housing cover and the component at the point where the felt element is arranged is very small and is only a few millimeters, for example. In addition, foams, for example, are very difficult or complex to apply at the desired location. In contrast to this, such a felt element, as explained in more detail below, can, for example, simply be glued on as a felt strip similar to an adhesive strip. In addition, felt has other very good properties that enable it to be used in a high-voltage system or that are very advantageous when used in a high-voltage system. On the one hand, felt is electrically insulating and is also flame retardant. For example, wool felt is generally not combustible at all and only chars when exposed to direct fire from approximately 320° C. But other types of felt and artificial felts are also flame retardant. This means that felt also meets the requirements for flame retardance of materials or equipment according to the test standard for flammability TL 1010. In addition, as described, felt has very good pressure and sound absorption properties. By using such a felt element, the punch loads mentioned at the beginning or general mechanical loads can also be absorbed and distributed much better. In addition, felt elements are available in large quantities and are inexpensive. Damage and acoustic abnormalities can thus be avoided in a simple and very cost-effective manner.

The felt element can include, for example, artificial felt and/or natural felt as the felt material. Artificial felt comprises artificially produced fibers, while natural felt comprises fibers made of animal hair. A combination of both is also conceivable.

In principle, the at least one felt element can be used at any point of the battery arrangement, in particular inside the battery housing or also outside. The support of the housing cover in relation to a battery component arranged in the battery housing is very advantageous, since due to the large dimensions of such a housing cover and moreover the typically large dimensions of battery modules, due to which the cover can only be supported at a few support points or partitions, the housing cover in particular is very susceptible to vibration and sagging. These vulnerabilities can now advantageously be eliminated by providing the at least one felt element. Due to the electrically insulating properties of the felt element, it can also be arranged at any point between the housing cover and the battery component. In addition, multiple such felt elements can also be provided in the battery housing, which, for example, support the cover at multiple support points or support sections relative to the component or support it relative to multiple components.

The combination of housing tray and housing cover makes it possible, for example, to provide a cuboid component which encloses an essentially cuboid receiving area. The housing cover can be designed in the form of a plate, for example, but other designs are also conceivable. For example, the housing tray and cover can also be provided as similarly shaped upper and lower parts of the battery housing. The housing tray typically represents a lower side of the battery housing with respect to a vehicle vertical axis of the vehicle in which the battery arrangement is used, while the housing cover can provide an upper part of the battery housing. However, an inverted structure or installation in a motor vehicle is also conceivable. The housing tray and the housing cover are preferably manufactured from metal, but can in principle be made of any material.

In an advantageous embodiment of the invention, the at least one battery component represents a battery module arranged in the receiving area. The housing cover can thus be placed or supported not only on side walls or partitions that separate the receiving areas from one another, but now also on intermediate support points on the battery modules located between such partitions or side walls. Vibrations can thus be damped or suppressed in a particularly simple manner. In addition, in the case of loads on the cover, a particularly even load distribution can be provided.

In general, the battery housing can have not only one receiving area for receiving a single battery module, but also multiple receiving areas for receiving multiple battery modules. The receiving areas can be spatially separated from one another by side walls or partitions of the battery housing, which are, for example, perpendicular to a housing base of the housing tray. In a state arranged on the housing tray, the housing cover can rest on a peripheral edge region of the housing tray, as well as on the end faces of these partitions. In addition, the housing cover can be screwed to the housing tray, in particular also on the peripheral edge area or frame that is provided by the housing tray, as well as with the end faces of the partitions. Battery modules are arranged in the receiving areas. Said felt elements can now be arranged between these battery modules and the housing cover in order to additionally support the housing cover and to damp vibrations of the housing cover.

In principle, however, the battery component can also be any other component in the battery housing that is different from a battery module or also a component of the battery housing itself, for example a partition or a housing of an electronic component, a support element, a cable holder, or the like.

It represents a further advantageous embodiment of the invention when the battery module includes a battery cell arrangement, in particular a cell stack, wherein the battery cell arrangement comprises multiple battery cells, wherein the battery module also includes a cooling device which is arranged on a side of the battery cell arrangement facing toward the housing cover, wherein the felt element is arranged on the cooling device. The felt element does not necessarily have to be arranged directly on the battery cells of such a battery module, which is generally also conceivable, but can be arranged on a cooling device of the battery module arranged on the cells. A direct support of the housing cover on the cells can thus advantageously be avoided. As a result, the cells are even better protected. However, it is also conceivable that such a cooling device is part of the housing cover itself. The felt element can then be arranged accordingly between the cooling device, which is provided by the housing cover, and the upper side of a battery module, which does not necessarily have to be provided by a cooling device.

The cooling device is also preferably designed as an active cooling device and includes cooling channels through which a coolant can flow. Particularly efficient cooling of the battery cells can thus be provided.

In a further advantageous embodiment of the invention, the battery module includes a frame that extends around the cell arrangement and includes frame walls that each include end faces facing toward the housing cover, wherein the cooling device is arranged on the frame and wherein the felt element is arranged in an area of the cooling device directly opposite to at least one of the end faces of the frame walls. This is particularly advantageous since in this way forces that are transmitted from the housing cover to the battery module via the felt element can be introduced into the frame walls of the battery module. These are particularly robust and application of force to the battery cells comprised by the battery module can be avoided. In order to be able to cool the battery cells as well as possible by means of the cooling device, it is also provided that the cooling channels extend in the area of these battery cells, but not necessarily in the area of the frame walls themselves. Therefore, the felt element can be arranged at a position of the cooling device where there is no cooling channel. As a result, there is no risk of a cooling channel being deformed or compressed by pressure action. In principle, however, the felt element can also be arranged at any other point on the cooling device, and for example also directly opposite to the battery cells of the battery module on the cooling device, for example in an area of the cooling device in which no cooling channels extend, for example between two cooling channels.

In a further advantageous embodiment of the invention, the felt element is designed as a felt strip that is elongated in a longitudinal extension direction, wherein the longitudinal extension direction is aligned parallel to the stacking direction of the cell stack and/or parallel to sections of cooling channels of the cooling device, and in particular along an extension direction of the end face of one of the frame walls opposite to the felt strip on the other side of the cooling device. The alignment of the felt element with its longitudinal extension direction parallel, for example, to the cooling channels is very advantageous since the felt element can then be positioned particularly easily between cooling channels or opposite to the frame walls and does not cross the cooling channels. This advantageously allows the felt element to be positioned at a particularly flat spot within the battery housing. This results in very uniform support of the housing cover. In principle, it is conceivable that the felt element even extends in the longitudinal extension direction over the entire length of a battery module of the battery arrangement. However, multiple felt elements arranged spaced apart from one another can also be arranged in this longitudinal direction. With regard to the geometric design and distribution of the felt strips, a particularly high degree of flexibility is provided, which allows a particularly good adaptation to the situation.

The dimension of the felt element in the longitudinal extension direction can be the size dimension of the felt element. Furthermore, the felt element can have a width perpendicular to the longitudinal extension direction, which is correspondingly smaller than a length in the longitudinal extension direction. In addition, the felt element has a height that is preferably less than 1 cm and is in the range of only a few millimeters, for example approximately 1 to 2 mm, in particular 1.3 mm. The felt element can in particular correspond in its height to the distance between the component and the housing cover. However, the initial height of the felt element is preferably dimensioned somewhat larger than the final distance between the component and the housing cover. As a result, the felt element is somewhat compressed when the cover is arranged on the housing tray. As a result, a particularly good damping property is provided by the felt element and a particularly high degree of stability. In addition, a secure contact on both components, namely the component and the housing cover, is thereby ensured.

In a particularly advantageous embodiment of the invention, the felt element is designed as a self-adhesive felt element having an adhesive side, in particular having only one adhesive side. This is particularly advantageous since it makes it particularly easy to attach the felt element. The felt element may generally include a first side and a second side spaced apart from one another by a thickness of the felt element, in particular a constant thickness, wherein the thickness provides the smallest dimension of the felt element that is significantly smaller than, for example, a length and a width of the felt element, in particular by one or more orders of magnitude. The first or second side can then be partially or preferably completely formed as the adhesive side of the felt element. This felt element can simply be glued to the desired location. In the state that is not yet arranged in the battery arrangement, the adhesive side of the felt element can be covered with a covering film, for example. This can be removed before the application to the desired component and the felt element can accordingly be glued to its desired position. Shorter felt elements are easier to attach. It is therefore very advantageous if several shorter felt elements are arranged along a desired attachment section, for example also at a distance from one another, rather than only a single, very long felt element.

According to a further advantageous embodiment of the invention, the felt element can be glued onto the battery component with the adhesive side. This enables a particularly simple attachment of the felt element. The correct placement of the felt element is also particularly easy. In a further advantageous embodiment of the invention, the felt element is glued to the housing cover with the adhesive side. The attachment to the housing cover is just as easy. The position at which the felt element is glued to the housing cover is then accordingly matched to the position of the part of the battery module that is to be contacted by the felt element when the housing cover is arranged on the housing tray. If multiple felt elements are comprised by the battery arrangement, these can also be partially glued to the battery module and partially to the housing cover with their respective adhesive sides.

It is especially advantageous that only a single adhesive side is provided. In other words, the felt element is not to be made adhesive on both sides. This has the advantage that relative movements between the cover and the component are still possible. This is particularly advantageous and increases the robustness of the arrangement.

Nevertheless, it would also be possible to glue the felt element to both components, namely the housing cover and the battery component, at the same time.

In a further advantageous embodiment of the invention, the battery arrangement includes multiple felt elements which are each arranged between the housing cover and the battery component and/or wherein the battery arrangement includes multiple battery components which are arranged in the receiving area, wherein at least one of the multiple felt elements is arranged between a respective battery component and the housing cover. The multiple respective components can in turn be respective battery modules. In principle, however, it is also conceivable to arrange a felt element between another battery component and the housing cover. By providing multiple such distributed felt elements, a uniform support and damping of the housing cover can be achieved. The specific design of the arrangement of the felt elements can be optimally adapted to the respective installation space situation and the desired damping behavior.

In particular a high-voltage battery for a motor vehicle can be provided by the battery arrangement. As described, such a high-voltage battery can include multiple battery modules, wherein a respective battery module can in turn comprise multiple battery cells. The battery cells can be formed as lithium-ion cells, for example.

Furthermore, the invention also relates to a motor vehicle having a battery arrangement according to the invention or one of its embodiments.

Furthermore, the invention also relates to a method for producing a battery arrangement for a motor vehicle, wherein a battery housing is provided having a housing tray that provides a receiving area for receiving at least one battery module, and having a housing cover that is arrangeable on the housing tray. Furthermore, a battery component is provided and the battery component is arranged in the battery housing so that it is at a distance from the housing cover when the housing cover is arranged on the housing tray. Furthermore, at least one felt element for vibration damping of mechanical vibrations of the housing cover is arranged in such a way that, after the housing cover has been arranged on the housing tray, it is located between the housing cover and the battery component and abuts, in particular flatly abuts, the housing cover and the at least one battery component.

The advantages mentioned for the battery arrangement according to the invention and its embodiments thus apply similarly to the method according to the invention.

In a further advantageous embodiment, the felt element is glued onto the battery component or the housing cover before the housing cover is arranged on the housing tray. As a result, the felt element can be arranged in a particularly simple manner. The handling as an adhesive felt strip is particularly easy.

The invention also includes refinements of the method according to the invention, which have features as have already been described in conjunction with the refinements of the battery arrangement according to the invention. For this reason, the corresponding refinements of the method according to the invention are not described again here.

The motor vehicle according to the invention is preferably designed as an automobile, in particular as a passenger car or truck, or as a passenger bus or motorcycle.

The invention also comprises the combinations of the features of the described embodiments. The invention thus also comprises implementations each comprising a combination of the features of multiple described embodiments, provided that the embodiments were not described as mutually exclusive.

### BRIEF DESCRIPTION OF THE FIGURES

Exemplary embodiments of the invention are described hereinafter. In the figures:

FIG. 1 shows a schematic representation of a top view of a battery arrangement in the form of a high-voltage battery without housing cover according to an exemplary embodiment of the invention;

FIG. 2 shows a schematic cross-sectional illustration of a battery arrangement from FIG. 1 according to one exemplary embodiment of the invention; and

FIG. 3 shows a schematic side view of a felt element for a battery arrangement according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

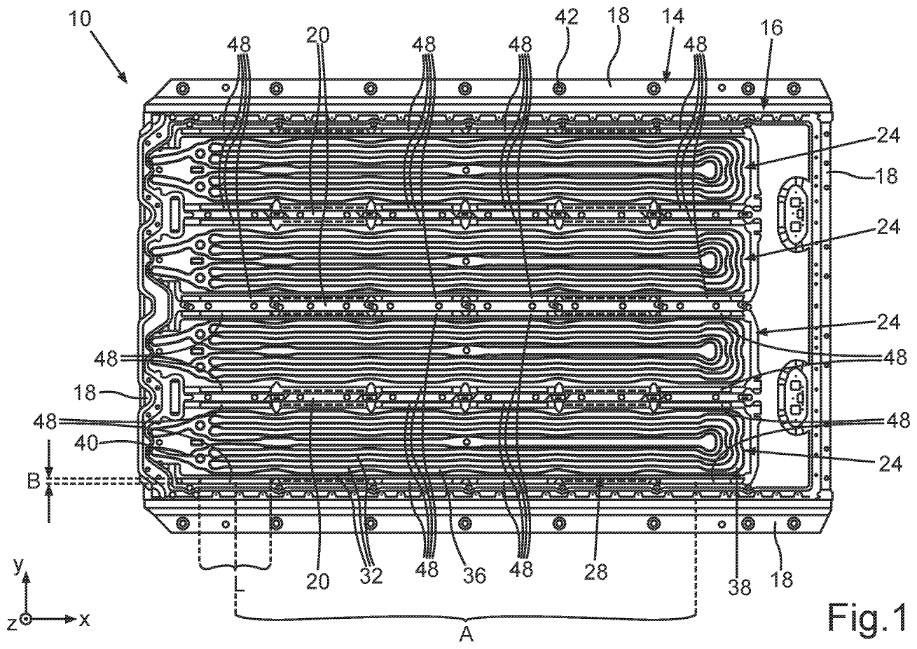

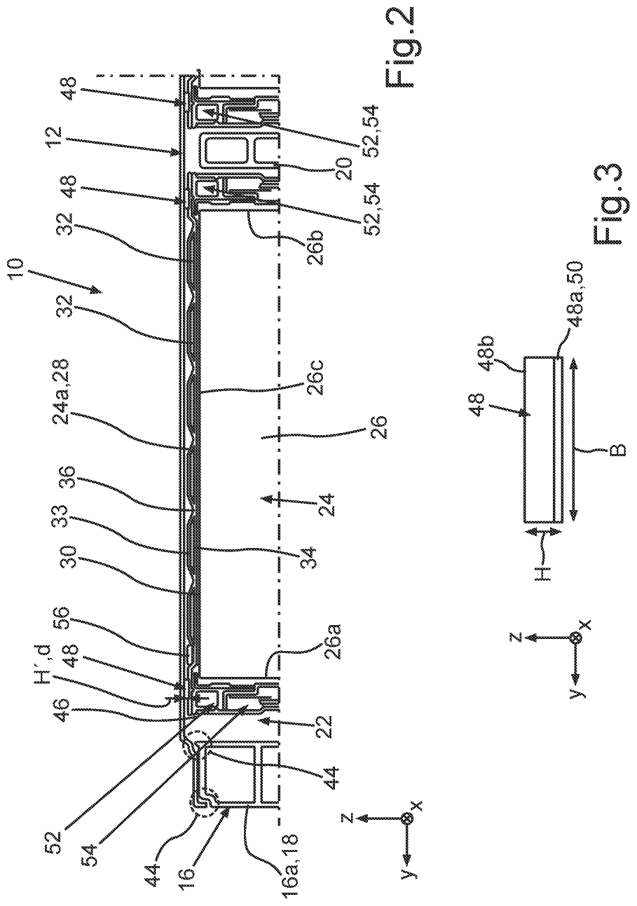

FIG. 1 shows a schematic representation of a battery arrangement 10 in the form of a high-voltage battery, but without housing cover 12 shown (cf. FIG. 2) according to one exemplary embodiment of the invention. The high-voltage battery 10 has a battery housing 14, of which only a housing tray 16 is shown in FIG. 1. The battery housing 14, in particular the housing tray 16, comprises a base and a peripheral frame 18 perpendicular thereto. In addition, the battery housing 14 can also include multiple separating webs 20 or partitions 20 in order to spatially separate a plurality of receiving areas 22 (cf. FIG. 2) for respective battery modules 24 (cf. also FIG. 2), in this example four battery modules 24.

FIG. 2 schematically shows a cross-sectional illustration of a part of the battery arrangement 10 from FIG. 1. In addition to the housing tray 16, the housing cover 12 is now also shown here. A side wall 16a of the housing tray 16 can also be seen as part of the frame 18, as well as a partition 20. These walls 16a, 20 are in the present case designed as hollow profiles. Respective battery modules 24 are arranged in the receiving areas 22 provided by the battery housing 14. A respective battery module 24 can in turn include multiple battery cells 26. In the present example, these are designed as prismatic battery cells 26, which are arranged adjacent to one another in the x-direction to form a cell stack. In the present case, the cells include a first side 26a and a second side 26b, on which the cell poles are also arranged. The sides 26a, 26c delimit the cell 26 in and counter to the y-direction, which is aligned perpendicularly to the illustrated stacking direction x. Furthermore, the battery module 24 in this example includes a cooling device 28 on the upper side 24b of the battery module 24, which faces toward the cover 12. The cooling device 28 is arranged accordingly on the respective upper sides 26c of the battery cells 26. To improve the thermal coupling between the cooling device 28 and the cells 26, a thermal interface material 30, for example a thermally conductive paste in the hardened state or a thermally conductive mat or the like, can be arranged between the upper side 26c of a respective cell 26 and the cooling device 28. In the present case, the cooling device 28 is formed having multiple cooling channels 32 through which a coolant can flow, only some of which are provided with a reference number for reasons of clarity. The cooling channels 32 are delimited on both sides by a respective cooling plate 33, 34 of the cooling device 28. These cooling plates 33, 34 contact one another locally at corresponding contact points 36 to form the cooling channels 32. The course of the cooling channels 32 can be seen particularly well in FIG. 1 in a top view of the cooling device 28, wherein the cooling channels 34 or their course can be recognized indirectly here through the shape embossing of the upper cooling plate 33 to form the channel structure. The cooling channels 32 extend essentially parallel to the stacking direction x of the respective battery modules 24. The cooling channels 32 are deflected in relation to the x-direction in an end area 38 of the cooling device 28, as well as partially in a beginning area 40 of the cooling device 28. Between this beginning and end area 40, 38, there is a section A of the cooling channels 32, in which these extend essentially parallel to the stacking direction x.

The housing cover 12 is fastened on the housing tray 16 at least in the area of the peripheral frame 18. The fastening can be carried out by means of screwing on at corresponding screw points 42, which are also shown in FIG. 1. Furthermore, the cover 12 can be sealed off from the trough 16 in the area of the frame 18 by one or more sealing tracks 44, the position of which is illustrated in FIG. 3 by corresponding circles. The interior 46 of the battery housing 14 can thus be hermetically sealed. As a result, the battery modules 24 are particularly well protected. Optionally, the cover 12 can also be supported on the partitions 20 extending between the receiving areas 22 and screwed thereon.

In conventional batteries, the unsupported cover area is very large due to the size of the battery modules. This can have a negative effect with regard to the pressure load as well as with regard to the acoustics in the overall system, since components that strike one another dynamically result in rattling. Mechanical loads applied to the system can also result in damage inside the battery.

This can now advantageously be avoided as follows: A felt element 48 in the form of a self-adhesive felt strip 48, which contacts both the relevant component and the cover 12, is now arranged between the cover 12 and at least one battery component in the interior 46 of the housing 14, in this case between the cover 12 and a battery module 24. The self-adhesive felt strip 48 therefore abuts the battery module 24, in this example the cooling device 28, which at the same time also provides the upper side 24a of the battery module 24, and on the other hand the lower side of the housing cover 12, i.e., the side of the cover 12 facing toward the interior 46 of the battery housing 14. In particular, multiple such self-adhesive felt strips 48 can be provided at different points between the cover 12 and the relevant battery modules 26. Such self-adhesive felt strips 48 are thus used as pressure and sound absorption elements, which provide numerous advantages. They are immediately available in large quantities, inexpensive, can be easily produced and applied in all sizes, meet the requirements for pressure and sound absorption and for the flame retardance of materials or equipment. Damage and acoustic abnormalities can be easily avoided in this way.

FIG. 3 schematically shows such a felt strip 48 for a battery arrangement 10 according to one exemplary embodiment of the invention. The felt strip 48 as shown in FIG. 3 has a height H and a width B, as well as a length L as defined schematically in FIG. 1 for the felt strip 48 shown in a top view. This felt strip 48 comprises an adhesive layer 50 on one side, in this case its lower side 48a. Alternatively, this adhesive layer 50 could also be provided on the upper side 48b of the felt strip 48. The felt strip 48 can thus be arranged at any point within the battery 10, for example, it can be glued to the housing cover 12 and/or at the desired points on the battery module 24. As shown in FIG. 3, the felt strips 48 are located in an edge area of the cooling device 28 directly above an edge area 52 of a frame 54 of the battery module 24 in relation to the z-direction. At this point, the upper side 24a of the battery module 24 is at a distanced from the cover 12, which corresponds to a height H′ of the felt strip 48 in the installed state, which is preferably slightly less than the initial height H of the felt strip 48 in the uninstalled state or when the cover 12 is not yet placed on the tray 16. The distance d can be 1.3 mm, for example, and the height H of the felt strip 48 in the initial state can be 2 mm, for example. As a result, the height H of the felt strip 48 is somewhat compressed in the z-direction to the height H′ when the battery 10 is assembled, in particular when the cover 12 is arranged on the tray 16. As a result, the felt strip 48 can compensate particularly well for mechanical vibrations of the cover 12.

The arrangement of the felt strip 48 above the corresponding edge areas 52 of the battery modules 24 is particularly advantageous since the felt strip 48 can be arranged in a particularly simple manner on a relatively flat surface in which no cooling channels 32 extend. A pressure load of the cooling channels 32 can thus be avoided.

FIG. 1 also schematically shows a possible distribution of such a number of felt strips 48 on the respective cooling devices 28 of the battery modules 24 in a top view. These can theoretically extend over the entire length of the battery modules 24 in the stacking direction x. However, this is not the case here. In this case, the strips 48 extend with their length L only over partial sections of the total length of the battery modules 24 in the x-direction. In particular, the felt strips 48 can be provided particularly flexibly in areas in which no screw connections or screw points are provided. Attachment to surfaces that are as flat as possible is advantageous for the most uniform possible pressure distribution and support of the cover 12. These requirements are very well met at the points shown in FIG. 1 in particular. The felt strips 48 therefore preferably extend essentially parallel to the stacking direction x or parallel to the cooling channel sections A between the beginning and end areas 40, 38 of the cooling device 28. Theoretically, however, it would also be possible to attach such felt strips 48 or felt elements 48 in general in a non-strip-shaped form, for example in a punctiform or round or square form, at any point on the battery module 24. The attachment of a felt element 48 is also conceivable between cooling channels 32 or recessed points 36 of the cooling device 28, for example also where the course of an electrical cable set 56 is shown in FIG. 2 in the present case. The felt strips 48 thus function as an absorption element in the battery 10 for absorbing or damping mechanical vibrations of the cover 12. The strips can be easily arranged or applied between the battery module 24 or the module cooling plates 28 and the battery cover 12, as illustrated in FIG. 2 and FIG. 1. In the overall system, i.e., in the high-voltage battery 10, these elements, i.e., the felt elements 48, can be distributed arbitrarily and in a targeted manner easily and in this way the desired forces in the system can be passed on or dissipated deliberately in order to protect the adjacent components, especially the battery modules 24. Furthermore, there is no longer the risk of acoustic abnormalities during operation, since the components, namely the cover 12 on the one hand and the modules 24 on the other hand, come into contact in a targeted manner, the felt strips 48 cushion the forces that occur, and the sound is absorbed by them.

Overall, the examples show how the invention can be used to provide pressure and sound absorption elements within a high-voltage storage system.

1. A battery arrangement for a motor vehicle, comprising:
a battery housing having a housing tray that provides a receiving area for receiving at least one battery module, and having a housing cover that is arranged on the housing tray;
at least one battery component arranged in the battery housing and at a distance from the housing cover;
wherein at least one felt element for vibration damping of mechanical vibrations of the housing cover is arranged between the housing cover and the battery component, so that the at least one felt element abuts the housing cover and the at least one battery component.

2. The battery arrangement according to claim 1, wherein the at least one battery component represents a battery module arranged in the receiving area.

3. The battery arrangement according to claim 1, wherein the battery module includes a battery cell arrangement, in particular a cell stack, which comprises multiple battery cells, and a cooling device which is arranged on a side of the battery cell arrangement facing toward the housing cover, wherein the felt element is arranged on the cooling device.

4. The battery arrangement according to claim 1, wherein the battery module includes a frame that extends around the cell arrangement and includes frame walls that each include end faces facing toward the housing cover, wherein the cooling device is arranged on the frame and the felt element is arranged in an area of the cooling device directly opposite to at least one of the end faces of the frame walls.

5. The battery arrangement according to claim 1, wherein the felt element is designed as a felt strip that is elongated in a longitudinal extension direction, wherein the longitudinal extension direction is aligned parallel to the stacking direction of the cell stack and/or parallel to sections of cooling channels of the cooling device, and in particular along an extension direction of the end face of one of the frame walls opposite to the felt strip on the other side of the cooling device.

6. The battery arrangement according to claim 1, wherein the felt element is designed as a self-adhesive felt element having an adhesive side, in particular having only one adhesive side, wherein the felt element is glued to the battery component using the adhesive side.

7. The battery arrangement according to claim 1, wherein the felt element is designed as a self-adhesive felt element having an adhesive side, in particular having only one adhesive side, wherein the felt element is glued to the housing cover using the adhesive side.

8. The battery arrangement according to claim 1, wherein the battery arrangement includes multiple felt elements which are each arranged between the housing cover and the battery component, and/or wherein the battery arrangement includes multiple battery components which are arranged in the receiving area, wherein at least one of the multiple felt elements is arranged between a respective battery component and the housing cover.

9. A method for producing a battery cell arrangement for a motor vehicle, including the following steps:
providing a battery housing having a housing tray that provides a receiving area for receiving at least one battery module, and having a housing cover that is arrangeable on the housing tray;
providing at least one battery component and arranging the battery component in the battery housing so that it is at a distance to the housing cover when the housing cover is arranged on the housing tray;
wherein at least one felt element for vibration damping of mechanical vibrations of the housing cover is arranged in such a way that, after the housing cover has been arranged on the housing tray, it is located between the housing cover and the battery component and abuts the housing cover and the at least one battery component.

10. The method according to claim 9, wherein the felt element is glued onto the battery component or the housing cover before the housing cover is arranged on the housing tray.

11. The battery arrangement according to claim 2, wherein the battery module includes a battery cell arrangement, in particular a cell stack, which comprises multiple battery cells, and a cooling device which is arranged on a side of the battery cell arrangement facing toward the housing cover, wherein the felt element is arranged on the cooling device.

12. The battery arrangement according to claim 2, wherein the battery module includes a frame that extends around the cell arrangement and includes frame walls that each include end faces facing toward the housing cover, wherein the cooling device is arranged on the frame and the felt element is arranged in an area of the cooling device directly opposite to at least one of the end faces of the frame walls.

13. The battery arrangement according to claim 3, wherein the battery module includes a frame that extends around the cell arrangement and includes frame walls that each include end faces facing toward the housing cover, wherein the cooling device is arranged on the frame and the felt element is arranged in an area of the cooling device directly opposite to at least one of the end faces of the frame walls.

14. The battery arrangement according to claim 2, wherein the felt element is designed as a felt strip that is elongated in a longitudinal extension direction, wherein the longitudinal extension direction is aligned parallel to the stacking direction of the cell stack and/or parallel to sections of cooling channels of the cooling device, and in particular along an extension direction of the end face of one of the frame walls opposite to the felt strip on the other side of the cooling device.

15. The battery arrangement according to claim 3, wherein the felt element is designed as a felt strip that is elongated in a longitudinal extension direction, wherein the longitudinal extension direction is aligned parallel to the stacking direction of the cell stack and/or parallel to sections of cooling channels of the cooling device, and in particular along an extension direction of the end face of one of the frame walls opposite to the felt strip on the other side of the cooling device.

16. The battery arrangement according to claim 4, wherein the felt element is designed as a felt strip that is elongated in a longitudinal extension direction, wherein the longitudinal extension direction is aligned parallel to the stacking direction of the cell stack and/or parallel to sections of cooling channels of the cooling device, and in particular along an extension direction of the end face of one of the frame walls opposite to the felt strip on the other side of the cooling device.

17. The battery arrangement according to claim 2, wherein the felt element is designed as a self-adhesive felt element having an adhesive side, in particular having only one adhesive side, wherein the felt element is glued to the battery component using the adhesive side.

18. The battery arrangement according to claim 3, wherein the felt element is designed as a self-adhesive felt element having an adhesive side, in particular having only one adhesive side, wherein the felt element is glued to the battery component using the adhesive side.

19. The battery arrangement according to claim 4, wherein the felt element is designed as a self-adhesive felt element having an adhesive side, in particular having only one adhesive side, wherein the felt element is glued to the battery component using the adhesive side.

20. The battery arrangement according to claim 5, wherein the felt element is designed as a self-adhesive felt element having an adhesive side, in particular having only one adhesive side, wherein the felt element is glued to the battery component using the adhesive side.
